(19) United States
(12) Patent Application Publication
(10) Pub. No.: US 2015/0003836 A1
(43) Pub. Date: Jan. 1, 2015

(54) VISIBLE LIGHT COMMUNICATION SYSTEM

(71) Applicant: Panasonic Corporation, Osaka (JP)

(72) Inventors: Shigeaki YAMASAKI, Osaka (JP); Eiji SHIOHAMA, Osaka (JP); Shojirou KIDO, Osaka (JP)

(21) Appl. No.: 14/314,319

(22) Filed: Jun. 25, 2014

(30) Foreign Application Priority Data
Jul. 1, 2013 (JP) 2013-138236

(51) Int. Cl. H04B 10/116

(52) U.S. Cl. CPC H04B 10/116
USPC 398/118

(57) ABSTRACT

The visible light communication system includes: a lighting fixture to send unique identification information by visible light communication; a receiver having a correction mode; and a server. In the correction mode, the receiver sends the identification information received from the lighting fixture, and in response to reception of positional information from the server, displays map information and the positional information on a display device, and waits for touch input to a touch panel. When receiving the touch input, the receiver sends corrected positional information determined by a position at which the touch input is received. When receiving the corrected positional information, the server replaces the positional information corresponding to the identification information with the corrected positional information.

### CROSS-REFERENCE TO RELATED APPLICATIONS

The application is based upon and claims the benefit of priority from Japanese Patent Application No. 2013-138236, filed on Jul. 1, 2013, the entire contents of which are incorporated herein by reference.

### TECHNICAL FIELD

The disclosure relates to a visible light communication system using visible light as communications medium.

### BACKGROUND ART

Recently, there has been available a visible light communication system (visible light ID system) including a lighting fixture (transmitter) configured to send information such as unique ID information by modulating visible light (light for lighting) emitted from the lighting fixture and a receiver configured to receive the visible light and demodulate the visible light to extract the ID information from the visible light.

Further, in such a conventional visible light communication system, the receiver sends the ID information obtained from the lighting fixture to a server, and the server sends back positional information (information indicative of a position at which the lighting fixture is placed) corresponding to the received ID information. In this case, an operation of registering a set of the ID information and the positional information for all of the lighting fixtures in the server is necessary.

As a background art aiming to facilitate such a registration operation, a light transmission system disclosed in document 1 (JP 2009-206620 A) has been proposed. The background art disclosed in document 1 includes: a lighting fixture to send ID information by visible light communication; a receiving terminal to obtain the ID information by visible light communication; a server to manage positional information corresponding to the ID information; and a setting terminal to register (set) the positional information in the server at installation of the lighting fixture.

The setting terminal includes a memory storing map data of a predetermined area including installation sites of lighting fixtures and a liquid crystal display with a touch panel, for example. In a situation where the setting terminal displays the map data on the liquid crystal monitor and receives the ID information from the lighting fixture, when a user touches the liquid crystal monitor to input an installation site of the lighting fixture whose ID information is received by the setting terminal, the setting terminal associates the positional information of the lighting fixture with the ID information of the same lighting fixture and thus creates a translation data table. Further, the setting terminal transmits the created translation data table (data table indicative of a correspondence relationship between the ID information and the positional information of the lighting fixture) to the server through communications medium. The server stores the translation data table sent from the setting terminal in a memory or the like, and thus registration of the positional information in the server is completed.

However, according to the background art disclosed in document 1, in order to correct the registered positional information, it is necessary to register the corrected positional information through the same operation as the initial registration operation. Therefore, such a correction operation would be troublesome.

### SUMMARY

In view of the above insufficiency, the present invention has aimed to facilitate the operation of correcting the registered positional information.

The visible light communication system of one aspect in accordance with the present invention includes: a lighting fixture configured to send identification information unique to the lighting fixture by visible light communication using visible light from a light source of the lighting fixture; a receiver configured to obtain the identification information from the visible light; and a server configured to communicate with the receiver. The server includes: a memory unit storing a correspondence relationship between the identification information and positional information indicative of an installation site of the lighting fixture; and a managing unit configured to, when receiving a provision request including the identification information, perform a provision process of referring to the correspondence relationship stored in the memory unit of the server, retrieving the positional information corresponding to the identification information included in the provision request, and sending the retrieved positional information. The receiver includes: a display and interface unit including a display device with a touch panel; and a control unit configured to perform one selected from a normal mode and a correction mode. The control unit is configured to, in the normal mode, when obtaining the identification information from the visible light, send the provision request including the identification information, and when receiving the positional information, control the display device to display the positional information and map information corresponding to the positional information. The control unit is configured to: in the correction mode, when obtaining the identification information from the visible light, send the provision request including the identification information, and when receiving the positional information, control the display device to display the positional information and the map information corresponding to the positional information and wait for touch input for corrected positional information to the touch panel; and when receiving the touch input for the corrected positional information to the touch panel, send a correction request including the identification information and the corrected positional information determined by a position at which the touch panel receives the touch input for the corrected positional information. The managing unit is configured to, when receiving the correction request, perform a correction process of replacing the positional information corresponding to the identification information included in the correction request in the correspondence relationship stored in the memory unit of the server by the corrected positional information included in the correction request.

### BRIEF DESCRIPTION OF THE DRAWINGS

FIG. 1 is a diagram illustrating a configuration of the visible light communication system of one embodiment in accordance with the present invention.

FIG. 2 is a diagram illustrating the database of the server in the above system.

FIG. 3 is a diagram illustrating the map information in the above system.

The figures depict one or more implementation in accordance with the present teaching, by way of example only, not by way of limitations.

### DETAILED DESCRIPTION

The visible light communication system of one embodiment in accordance with the present invention is described in detail with reference to drawings. Note that, the visible light communication system of the present embodiment is used in a building such as commercial premises and hospitals.

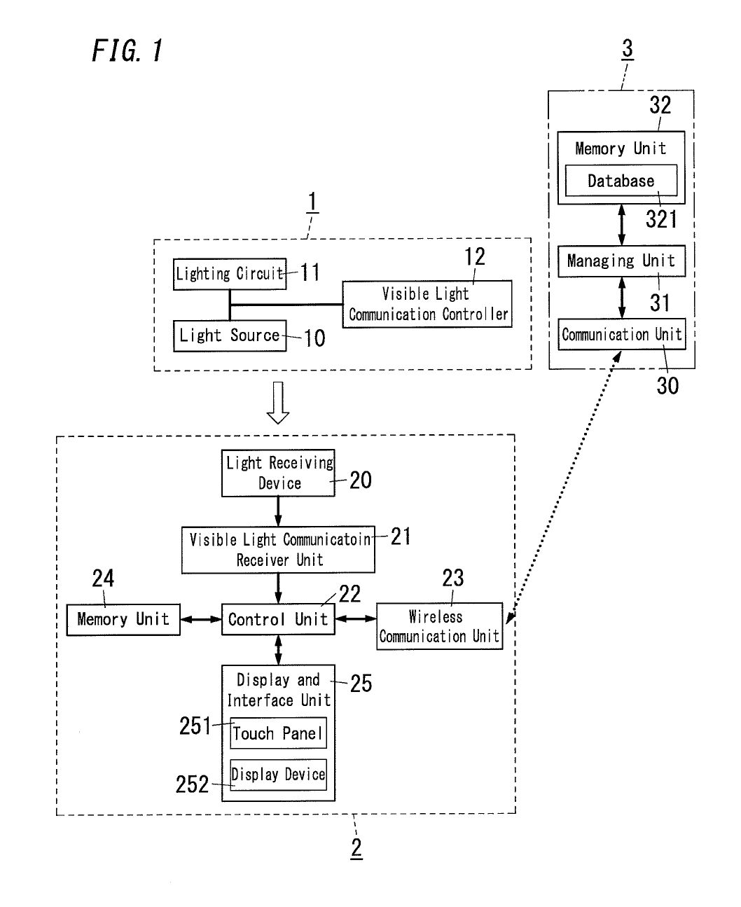

As shown in FIG. 1, the visible light communication system of the present embodiment includes a plurality of lighting fixtures 1, a receiver 2, and a server 3. Besides, FIG. 1 shows only one of the lighting fixtures 1 however the plurality of lighting fixtures 1 are installed in a building. Note that, the number of lighting fixtures 1 may be one.

The lighting fixture 1 includes a light source 10, a lighting circuit 11, and a visible light communication controller 12, for example. The lighting fixture 1 may be situated on a ceiling of a passage or a wall inside the building.

The light source 10 is configured to emit visible light. For example, the light source 10 may be constituted by a light emitting device such as a light emitting diode and an organic electroluminescent device, or a lamp such as an incandescent lamp and a fluorescent lamp. Note that, in the present embodiment, the light source 10 is constituted by at least one light emitting diode.

The lighting circuit 11 is configured to operate the light source 10. For example, the lighting circuit 11 converts AC energy (AC voltage and an AC current) supplied from a commercial power source into DC energy (DC voltage and a DC current) and supplies the resultant DC energy to the light source 10.

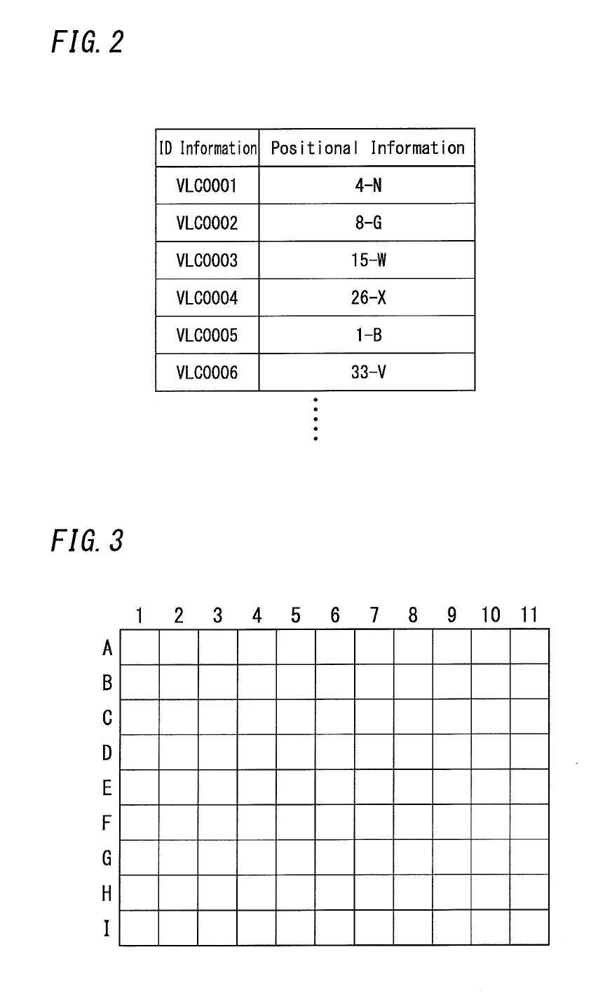

The visible light communication controller 12 sends ID information by superposing the ID information on the visible light (light for lighting) through modulation of the DC voltage or the DC current supplied from the lighting circuit 11 to the light source 10. The ID information is identification information uniquely allocated to the lighting fixture 1 (see FIG. 2). In brief, the visible light communication controller 12 is configured to send the unique identification information (ID information) by visible light communication using the visible light from the light source 10. Note that, such a type of the visible light communication controller 12 is well known and therefore the detailed configuration thereof is not shown and described.

As shown in FIG. 2, positional information (positional information of the lighting fixture 1) corresponding to (associated with) the ID information may be defined by a combination of a number and an alphabetical letter. For example, as shown in FIG. 3, a grid of rectangular squares is superimposed on a plan view (map) of a floor of the building. In this grid, to identify the positions of the rectangular squares, a column of the rectangular squares is designated by the number and a row of the rectangular squares is designated by the alphabetical letter. Positions on the map individually corresponding to the rectangular squares in the grid are treated as positions of the lighting fixtures 1. Note that, the way to express the positional information is not limited to the aforementioned way, but may be expressed by use of a combination of a latitude and a longitude. Additionally, the positional information may include a parameter indicative of a floor number of the building.

The receiver 2 includes a light receiving device 20, a visible light communication receiver unit 21, a control unit 22, a wireless communication unit (communication unit) 23, a memory unit 24, and a display and interface unit (display/interface unit) 25, for example.

The light receiving device 20 may be constituted by a photoelectric conversion device (e.g., a photodiode and a phototransistor) receiving visible light and converting the received visible light into an electric signal.

The visible light communication receiver unit 21 extracts the ID information by demodulating the electric signal outputted from the light receiving device 20, and provides the extracted ID information to the control unit 22.

The wireless communication unit 23 establishes data communications with the server 3 in a wireless communication scheme using electric waves as medium. Note that, such a wireless communication scheme may be preferably a scheme suitable for a wireless LAN, or a communication scheme for data communications provided by a mobile service provider (e.g., W-CDMA and CDMA 2000).

The memory unit 24 is constituted by an electrically-rewritable non-volatile semiconductor memory such as a flash memory, for example. The memory unit 24 stores (memorizes) ID information allocated to the receiver 2, and map information of the floor of the building.

The display and interface unit 25 includes a display device (display panel) 252 with a touch panel 251. For example, the display and interface unit 25 may be constituted by a liquid crystal display with a touch panel, a driving circuit for operating the liquid crystal display, and a detection circuit for detecting a position at which the touch panel receives touch input. In short, the display and interface unit 25 is a touchscreen.

The visible light communication receiver unit 21, the wireless communication unit 23, and the display and interface unit 25 that are described above are well known and therefore the detailed configurations thereof are not shown and described.

The control unit 22 is mainly constituted by a microcomputer, and is configured to perform the following various types of processes by executing programs stored in a memory of the microcomputer.

The control unit 22 is configured to perform one selected from a normal mode and a correction mode (either one of the normal mode and the correction mode).

In the normal mode, when obtaining the identification information (ID information) from the visible light, the control unit 22 sends (to the server 3) a provision request including the identification information (obtained identification information). When receiving the positional information, the control unit 22 controls the display device 252 to display the positional information and map information corresponding to the positional information. In this regard, the control unit 22 retrieves the map information from the memory unit 24. Further, in the normal mode, the control unit 22 waits for touch input for selecting the correction mode to the touch panel 251. When receiving the touch input for selecting the correction mode, the control unit 22 ends the normal mode and starts the correction mode.

In the correction mode, when obtaining the identification information (ID information) from the visible light, the control unit 22 sends (to the server 3) the provision request including the identification information (obtained identification information). When receiving the positional information, the control unit 22 controls the display device 252 to display the positional information and the map information corresponding to the positional information and waits for touch input for corrected positional information to the touch panel 251. In this regard, the control unit 22 retrieves the map information from the memory unit 24. When receiving the touch input for the corrected positional information to the touch panel 251, the control unit 22 sends (to the server 3) a correction request including the identification information and the corrected positional information determined by a position at which the touch panel 251 receives the touch input for the corrected positional information. When receiving a correction completion notice, the control unit 22 ends the correction mode and starts the normal mode.

The server 3 is constituted by a combination (set) of a general-purpose computer system and software dedicated to servers, for example. The server 3 includes a communication unit 30, a managing unit 31, and a memory unit 32.

The communication unit 30 is configured to communicate with the receiver 2 (the communication unit 23). In the present embodiment, the communication unit 30 is configured to perform data communications via a wired LAN or a wireless LAN. For example, when the communication unit 30 performs the data communications through the wireless LAN, the server 3 can directly communicate with the receiver 2. Alternatively, when the communication unit 30 performs the data communications through the wired LAN, the server 3 can communicate with the receiver 2 by way of a base station of a wireless LAN.

The memory unit 32 is constituted by an external storage such as a hard disc drive, for example. As shown in FIG. 2, the memory unit 32 stores database 321 in which the ID information and the positional information (positional information indicative of the installation site of the lighting fixture 1) corresponding to the ID information are registered for each lighting fixture 1. In brief, the memory unit 32 stores the correspondence relationship (see FIG. 2) between the identification information (ID information) and the positional information indicative of the installation site of the lighting fixture 1.

The managing unit 31 is configured to manage the database 321. For example, as described below, the managing unit 31 performs a provision process for providing the positional information to the receiver 2 and a correction process for correcting the registered positional information that is associated with the ID information and registered in the database 321.

When receiving the provision request including the identification information, the managing unit 31 performs the provision process of referring to the correspondence relationship stored in the memory unit 32 of the server 3, retrieving the positional information corresponding to the identification information included in the provision request, and sending the retrieved positional information (to the receiver 2).

When receiving the correction request, the managing unit 31 performs the correction process of replacing the positional information corresponding to the identification information included in the correction request in the correspondence relationship (the database 321) stored in the memory unit 32 of the server 3 by the corrected positional information included in the correction request. The managing unit 31 sends the correction completion notice in response to completion of the correction process (to the receiver 2).

Next, a basic operation mode of the visible light communication system of the present embodiment is described.

First, when receiving the ID information (e.g., VLC0002) from the visible light communication receiver unit 21, the control unit 22 of the receiver 2 creates a transmission frame including the received ID information (VLC0002) and a request for provision of the positional information to the server 3 (the provision request) and outputs the created transmission frame to the wireless communication unit 23. The wireless communication unit 23 performs modulation with the transmission frame received from the control unit 22 to create a wireless signal and sends the resultant wireless signal to the server 3.

When receiving the ID information (VLC0002) that is received by the communication unit 30, the managing unit 31 of the server 3 reads out the positional information (8-G) corresponding to the received ID information (VLC0002) from the database 321 (see FIG. 2) and controls the communication unit 30 to send the positional information (8-G) as a reply to the receiver 2 (the provision process).

The control unit 22 of the receiver 2 receives the positional information (8-G) from the wireless communication unit 23 that receives the reply (i.e., the positional information) from the server 3, and reads out from the memory unit 24 the map information corresponding to the received positional information (8-G) (i.e., the map information including the installation site of the lighting fixture 1 which is a sender of the ID information; note that this definition is applied to the map information in the same situation). Further, the control unit 22 controls the liquid crystal display (the display device 252) of the display and interface unit 25 to display the map information read out from the memory unit 24 and the positional information (8-G) received from the server 3 so that the position (position image) indicative of the positional information (8-G) is superimposed on the map (map image) given by the map information. As a result, a user carrying the receiver 2 can know a current position of the user (the installation site of the lighting fixture 1) on the map displayed on the liquid crystal display (the display device 252) of the receiver 2.

Next, an operation of the control unit 22 in the correction mode is described. The correction mode is an operation mode in which the control unit 22 of the receiver 2 is allowed to correct the positional information registered in the database 321 of the server 3. In contrast, the basic operation mode described above is referred to as the normal mode.

When the display and interface unit 25 receives the touch input for selecting the correction mode, the control unit 22 of the receiver 2 starts the correction mode.

First, when receiving from the visible light communication receiver unit 21 the ID information (e.g., VLC0002) of the lighting fixture 1 whose positional information is to be corrected, the control unit 22 creates the transmission frame for requesting the provision of the positional information corresponding to this ID information (VLC0002) (the provision request) and outputs the created transmission frame to the wireless communication unit 23. The wireless communication unit 23 performs modulation with the transmission frame received from the control unit 22 to create a wireless signal and sends the resultant wireless signal to the server 3.

When receiving the ID information (VLC0002) that is received by the communication unit 30, the managing unit 31 of the server 3 reads out the positional information (8-G) corresponding to the received ID information (VLC0002) from the database 321 and controls the communication unit 30 to send the positional information (8-G) as a reply to the receiver 2 (the provision process).

The control unit 22 of the receiver 2 receives the positional information (8-G) from the wireless communication unit 23 that receives the reply from the server 3, and reads out from the memory unit 24 the map information corresponding to the received positional information (8-G). Further, the control unit 22 controls the liquid crystal display (the display device 252) to display the map information and the positional information so that the position image indicative of the positional information is superimposed on the map image given by the map information. When a person (worker) performing the correction operation touches a corrected position (e.g., 8-F) on the map displayed on the liquid crystal display (the display device 252), the display and interface unit 25 receives the touch input and outputs the positional information (the position of the square) corresponding to the position touched, to the control unit 22.

When receiving the positional information (8-F) from the display and interface unit 25, the control unit 22 controls the liquid crystal display (the display device 252) of the display and interface unit 25 to display a confirmation button. When the worker touches the button and thus the display and interface unit 25 receives such touch input, the corrected positional information is fixed. When the corrected positional information is fixed, the control unit 22 creates a transmission frame including the fixed positional information (8-F), the ID information (VLC0002), and a request for correction of the positional information to the server 3 (the correction request), and outputs the created transmission frame to the wireless communication unit 23. The wireless communication unit 23 performs modulation with the transmission frame received from the control unit 22 to create a wireless signal and sends the resultant wireless signal to the server 3.

When receiving the ID information (VLC0002) and the positional information (8-F) that are received by the communication unit 30, the managing unit 31 of the server 3 rewrites the database 321 by replacing, with the corrected positional information (8-F), the positional information (8-G) corresponding to the received ID information (VLC0002) (the correction process). Thereafter, the managing unit 31 controls the communication unit 30 to send a frame including a correction completion message (correction completion notice) as a reply to the receiver 2.

When receiving the correction completion message (correction completion notice) by receiving the reply from the server 3 by the wireless communication unit 23, the control unit 22 of the receiver 2 ends the correction mode and starts the normal mode.

As described above, the visible light communication system of the present embodiment includes at least one lighting fixture 1 configured to send unique indentification information by visible light communication, and the server 3 configured to store the identification information and the positional information of the lighting fixture 1 and manage the identification information and the positional information of the lighting fixture 1. Further, the visible light communication system of the present embodiment includes the receiver 2 configured to receive the identification information from the lighting fixture 1 by visible light communication and obtain the positional information corresponding to the received identification information from the server 3. The receiver 2 includes the visible light communication receiver unit 21 configured to obtain the identification information from the received visible light, the communication unit (wireless communication unit 23) configured to communicate with the server 3, and the memory unit 24 storing the map information of a place at which the lighting fixture 1 is situated. Additionally, the receiver 2 includes the display and interface unit 25 including the display device 252 attached with the touch panel 251, and the control unit 22 configured to control each unit. The control unit 22 has the normal mode. In the normal mode, the control unit 22 sends the identification information obtained by the visible light communication receiver unit 21 to the server 3 via the wireless communication unit 23, and controls the display device 252 of the display and interface unit 25 to display the positional information corresponding to the identification information sent from the server 3 together with the map information retrieved from the memory unit 24. Further, the control unit 22 has the correction mode. In the correction mode, the control unit 22 sends the identification information obtained by the visible light communication receiver unit 21 to the server 3 via the wireless communication unit 23, and controls the display device 252 of the display and interface unit 25 to display the positional information corresponding to the identification information sent from the server 3 together with the map information retrieved from the memory unit 24. Further, in the correction mode, the control unit 22 obtains from the map information the positional information corresponding to the position at which the touch panel 251 of the display and interface unit 25 receives the touch input, and sends the obtained positional information together with the identification information to the server 3 via the wireless communication unit 23. The control unit 22 is configured to perform (execute) one selected from the normal mode and the correction mode. The sever 3 is configured to replace the positional information corresponding to the identification information obtained from the receiver 2 by wireless communication, with the positional information obtained from the receiver 2 together with the identification information.

In summary, the visible light communication system of the present embodiment displays the positional information registered in the server 3, together with the map information on the display device 252 of the receiver 2. The visible light communication system of the present embodiment uses the position on the map determined by the touch input to the touch panel 251 as the corrected positional information, and corrects the positional information in the server 3. Accordingly, in contrast to the conventional instance in which correction of the positional information requires performing the registration operation again, the visible light communication system of the present embodiment can facilitate the operation of correcting the registered positional information.

Additionally, in the present embodiment, the map information is stored in the memory unit 24 of the receiver 2. Hence, in contrast to a configuration where the map information is stored in the server 3, it is unnecessary to send the map information from the server 3 to the receiver 2. Consequently, it is possible to reduce an amount of data traffic in a communication line between the server 3 and the receiver 2, and thus improve a response speed of the receiver 2 in the correction operation.

Note that, instead of storing the map information in the memory unit 24 of the receiver 2, the map information may be stored in the memory unit 32 (or the database 321) of the server 3. In such a modification of the visible light communication system of the present embodiment, when receiving the provision request of the positional information, the managing unit 31 of the server 3 may retrieve the positional information corresponding to the ID information and the map information corresponding the positional information from the memory unit 32, and sends them to the receiver 2. In other words, the memory unit 32 stores the map information. In the provision process, the managing unit 31 retrieves the map information from the memory unit 32 and sends the retrieved map information. The control unit 22 obtains the map information by receiving the map information (sent from the server 3).

Next, the operation in the normal mode according to the modification is described.

First, when receiving the ID information (e.g., VLC0002) from the visible light communication receiver unit 21, the control unit 22 of the receiver 2 creates a transmission frame including the received ID information (VLC0002) and the request for provision of the positional information to the server 3 (the provision request) and outputs the created transmission frame to the wireless communication unit 23. The wireless communication unit 23 performs modulation with the transmission frame received from the control unit 22 to create a wireless signal and sends the resultant wireless signal to the server 3.

When receiving the ID information (VLC0002) that is received by the communication unit 30, the managing unit 31 of the server 3 reads out the positional information (8-G) corresponding to the received ID information (VLC0002) from the database 321 (see FIG. 2), reads out the map information corresponding to this positional information (8-G) from the memory unit 32, and controls the communication unit 30 to send the positional information (8-G) and the map information as a reply to the receiver 2 (the provision process).

The control unit 22 of the receiver 2 receives the positional information (8-G) and the map information from the wireless communication unit 23 that receives the reply from the server 3, and then controls the liquid crystal display (the display device 252) of the display and interface unit 25 to display the received positional information (8-G) and the received map information so that the position image indicative of the positional information (8-G) is superimposed on the map image given by the map information. As a result, a user carrying the receiver 2 can know a current position of the user (the installation site of the lighting fixture 1) on the map displayed on the liquid crystal display (the display device 252) of the receiver 2.

Next, the operation in the correction mode according to the modification is described.

When the display and interface unit 25 receives the touch input for selecting the correction mode, the control unit 22 of the receiver 2 starts the correction mode.

First, when receiving from the visible light communication receiver unit 21 the ID information (e.g., VLC0002) of the lighting fixture 1 whose positional information is to be corrected, the control unit 22 creates the transmission frame for requesting the provision of the positional information corresponding to this ID information (VLC0002) (the provision request) and outputs the created transmission frame to the wireless communication unit 23. The wireless communication unit 23 performs modulation with the transmission frame received from the control unit 22 to create a wireless signal and sends the resultant wireless signal to the server 3.

When receiving the ID information (VLC0002) that is received by the communication unit 30, the managing unit 31 of the server 3 reads out the positional information (8-G) corresponding to the received ID information (VLC0002) from the database 321 (see FIG. 2), reads out the map information corresponding to this positional information (8-G) from the memory unit 32, and controls the communication unit 30 to send the positional information (8-G) and the map information as a reply to the receiver 2 (the provision process).

The control unit 22 of the receiver 2 receives the positional information (8-G) and the map information from the wireless communication unit 23 that receives the reply from the server 3, and then controls the liquid crystal display (the display device 252) of the display and interface unit 25 to display the received positional information (8-G) and the received map information so that the position image indicative of the positional information (8-G) is superimposed on the map image given by the map information. When a person (worker) performing the correction operation touches a corrected position (e.g., 8-F) on the map displayed on the liquid crystal display (the display device 252), the display and interface unit 25 receives the touch input and outputs the positional information (the position of the square) corresponding to the position touched, to the control unit 22.

When receiving the positional information (8-F) from the display and interface unit 25, the control unit 22 controls the liquid crystal display (the display device 252) of the display and interface unit 25 to display the confirmation button. When the worker touches the button and thus the display and interface unit 25 receives such touch input, the corrected positional information is fixed. When the corrected positional information is fixed, the control unit 22 creates a transmission frame including the fixed positional information (8-F), the ID information (VLC0002), and a request for correction of the positional information to the server 3 (the correction request), and outputs the created transmission frame to the wireless communication unit 23. The wireless communication unit 23 performs modulation with the transmission frame received from the control unit 22 to create a wireless signal and sends the resultant wireless signal to the server 3.

When receiving the ID information (VLC0002) and the positional information (8-F) that are received by the communication unit 30, the managing unit 31 of the server 3 rewrites the database 321 by replacing, with the corrected positional information (8-F), the positional information (8-G) corresponding to the received ID information (VLC0002) (the correction process). Thereafter, the managing unit 31 controls the communication unit 30 to send a frame including a correction completion message (correction completion notice) as a reply to the receiver 2.

When receiving the correction completion message (correction completion notice) by receiving the reply from the server 3 by the wireless communication unit 23, the control unit 22 of the receiver 2 ends the correction mode and starts the normal mode.

Accordingly, this modification of the visible light communication system includes at least one lighting fixture 1 configured to send unique identification information by visible light communication, and the server 3 configured to store the identification information and the positional information of the lighting fixture 1 and manage the identification information and the positional information of the lighting fixture 1. Further, the modification of the visible light communication system of the present embodiment includes the receiver 2 configured to receive the identification information from the lighting fixture 1 by visible light communication and obtain the positional information corresponding to the received identification information from the server 3. The server 3 includes the communication unit 30 configured to communicate with the receiver 2, the memory unit 32 (the database 321) storing the map information of a place at which the lighting fixture 1 is situated and storing the positional information of the lighting fixture 1 associated with the identification information, and the managing unit 31 configured to manage the communication unit 30 and the memory unit 32 (the database 321). The receiver 2 includes the visible light communication receiver unit 21 configured to obtain the identification information from the received visible light, the communication unit (wireless communication unit 23) configured to communicate with the server 3, the display device 252 attached with the touch panel 251, and the control unit 22 configured to control each unit. The control unit 22 has the normal mode. In the normal mode, the control unit 22 sends the identification information obtained by the visible light communication receiver unit 21 to the server 3 via the wireless communication unit 23, and controls the display device 252 of the display and interface unit 25 to display the positional information corresponding to the identification information sent from the server 3 and the map information received from the server 3 together with the positional information. Further, the control unit 22 has the correction mode. In the correction mode, the control unit 22 sends the identification information obtained by the visible light communication receiver unit 21 to the server 3 via the wireless communication unit 23, and controls the display device 252 of the display and interface unit 25 to display the positional information corresponding to the identification information sent from the server 3 and the map information received from the memory unit 24 together with the positional information. Further, in the correction mode, the control unit 22 obtains from the map information the positional information corresponding to the position at which the touch panel 251 of the display and interface unit 25 receives the touch input, and sends the obtained positional information together with the identification information to the server 3 via the wireless communication unit 23. The control unit 22 is configured to perform (execute) one selected from the normal mode and the correction mode. The sever 3 is configured to replace the positional information corresponding to the identification information obtained from the receiver 2 by wireless communication, with the positional information obtained from the receiver 2 together with the identification information.

In summary, the modification of the visible light communication system of the present embodiment can display the positional information and the map information registered in the server 3 on the display device 252 of the receiver 2. The modification of the visible light communication system of the present embodiment can use the position on the map determined by the touch input to the touch panel 251 as the corrected positional information, and correct the positional information in the server 3. Accordingly, in contrast to the conventional instance in which correction of the positional information requires performing the registration operation again, the modification of the visible light communication system of the present embodiment can facilitate the operation of correcting the registered positional information.

Additionally, the map information is stored in the memory unit 32 (the database 321) of the server 3 instead of the memory unit 24 of the receiver 2. Hence, even when the positional information is corrected by use of a plurality of receivers 2, there is an advantageous effect that it is unnecessary to confirm consistency of the map information between the plurality of receivers 2.

Note that, in the above description, the receiver 2 available for normal users is used to correct the positional information registered in the server 3, however, the receiver 2 dedicated for correction operation can be also used.

As apparent from the embodiment mentioned above, the visible light communication system of the first aspect in accordance with the present invention includes: a lighting fixture (1) configured to send identification information (ID information) unique to the lighting fixture (1) by visible light communication using visible light from a light source (10) of the lighting fixture (1); a receiver (2) configured to obtain the identification information from the visible light; and a server (3) configured to communicate with the receiver (2). The server (3) includes: a memory unit (32) storing a correspondence relationship between the identification information and positional information indicative of an installation site of the lighting fixture (1); and a managing unit (31) configured to, when receiving a provision request including the identification information, perform a provision process of referring to the correspondence relationship stored in the memory unit (32) of the server (3), retrieving the positional information corresponding to the identification information included in the provision request, and sending the retrieved positional information. The receiver (2) includes: a display and interface unit (25) including a display device (252) with a touch panel (251); and a control unit (22) configured to perform one selected from a normal mode and a correction mode. The control unit (22) is configured to, in the normal mode, when obtaining the identification information from the visible light, send the provision request including the identification information, and when receiving the positional information, control the display device (252) to display the positional information and map information corresponding to the positional information. The control unit (22) is configured to: in the correction mode, when obtaining the identification information from the visible light, send the provision request including the identification information, and when receiving the positional information, control the display device (252) to display the positional information and the map information corresponding to the positional information and wait for touch input for corrected positional information to the touch panel (251); and when receiving the touch input for the corrected positional information to the touch panel (251), send a correction request including the identification information and the corrected positional information determined by a position at which the touch panel (251) receives the touch input for the corrected positional information. The managing unit (31) is configured to, when receiving the correction request, perform a correction process of replacing the positional information corresponding to the identification information included in the correction request in the correspondence relationship stored in the memory unit (32) of the server (3) by the corrected positional information included in the correction request.

The visible light communication system of the first aspect can display the registered positional information and the map information on the display device 252 of the receiver 2. The visible light communication system can use the position on the map determined by the touch input to the touch panel 251 as the corrected positional information, and correct the positional information in the server 3. Accordingly, in contrast to the conventional instance in which correction of the positional information requires performing the registration operation again, the visible light communication system can facilitate the operation of correcting the registered positional information.

According to the visible light communication system of the second aspect in accordance with the present invention, based on the first aspect, the receiver (2) further includes a memory unit (24) storing the map information. The control unit (22) is configured to retrieve the map information from the memory unit (24) of the receiver (2).

According to the visible light communication system of the third aspect in accordance with the present invention, based on the first aspect, the memory unit (32) of the server (3) stores the map information. The managing unit (31) is configured to, in the provision process, retrieve the map information from the memory unit (32) of the server (3) and send the retrieved map information. The control unit (22) is configured to retrieve the map information by receiving the map information.

According to the visible light communication system of the fourth aspect in accordance with the present invention, based on any one of the first to third aspects, the control unit (22) is configured to: in the normal mode, wait for touch input for selecting the correction mode to the touch panel (251); and when receiving the touch input for selecting the correction mode, end the normal mode and start the correction mode.

According to the visible light communication system of the fifth aspect in accordance with the present invention, based on the fourth aspect, the managing unit (31) is configured to send correction completion notice in response to completion of the correction process. The control unit (22) is configured to, when receiving the correction completion notice, end the correction mode and start the normal mode.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A visible light communication system comprising:
a lighting fixture configured to send identification information unique to the lighting fixture by visible light communication using visible light from a light source of the lighting fixture;
a receiver configured to obtain the identification information from the visible light; and
a server configured to communicate with the receiver,
the server including:
a memory unit storing a correspondence relationship between the identification information and positional information indicative of an installation site of the lighting fixture; and
a managing unit configured to, when receiving a provision request including the identification information, perform a provision process of referring to the correspondence relationship stored in the memory unit of the server, retrieving the positional information corresponding to the identification information included in the provision request, and sending the retrieved positional information,
the receiver including:
a display and interface unit including a display device with a touch panel; and
a control unit configured to perform one selected from a normal mode and a correction mode,
the control unit being configured to, in the normal mode, when obtaining the identification information from the visible light, send the provision request including the identification information, and when receiving the positional information, control the display device to display the positional information and map information corresponding to the positional information,
the control unit being configured to: in the correction mode
when obtaining the identification information from the visible light, send the provision request including the identification information, and when receiving the positional information, control the display device to display the positional information and the map information corresponding to the positional information and wait for touch input for corrected positional information to the touch panel; and
when receiving the touch input for the corrected positional information to the touch panel, send a correction request including the identification information and the corrected positional information determined by a position at which the touch panel receives the touch input for the corrected positional information, and
the managing unit being configured to, when receiving the correction request, perform a correction process of replacing the positional information corresponding to the identification information included in the correction request in the correspondence relationship stored in the memory unit of the server by the corrected positional information included in the correction request.

2. The visible light communication system according to claim 1, wherein:
the receiver further includes a memory unit storing the map information; and
the control unit is configured to retrieve the map information from the memory unit of the receiver.

3. The visible light communication system according to claim 1, wherein:
the memory unit of the server stores the map information;
the managing unit is configured to, in the provision process, retrieve the map information from the memory unit of the server and send the retrieved map information; and
the control unit is configured to retrieve the map information by receiving the map information.

4. The visible light communication system according to claim 1, wherein
the control unit is configured to: in the normal mode,
wait for touch input for selecting the correction mode to the touch panel; and
when receiving the touch input for selecting the correction mode, end the normal mode and start the correction mode.

5. The visible light communication system according to claim 4, wherein:
the managing unit is configured to send correction completion notice in response to completion of the correction process; and
the control unit is configured to, when receiving the correction completion notice, end the correction mode and start the normal mode.
